(19) United States
(12) Patent Application Publication
(10) Pub. No.: US 2023/0128367 A1
(43) Pub. Date: Apr. 27, 2023

(54) ENVIRONMENT AND LOCATION-BASED DATA ACCESS MANAGEMENT SYSTEMS AND METHODS

(71) Applicant: Intertrust Technologies Corporation, Milpitas, CA (US)

(72) Inventors: Kristo Iila, Tallinn (EE); Eric Swenson, Soquel, CA (US); Christopher Kalima, Mammoth Lakes, CA (US); Oleg Mürk, San Francisco, CA (US); Sung Yong Chun, Millbrae, CA (US); Michael Manente, Sudbury, MA (US)

(73) Assignee: Intertrust Technologies Corporation, Milpitas, CA (US)

(21) Appl. No.: 17/973,364

(22) Filed: Oct. 25, 2022

Related U.S. Application Data
(60) Provisional application No. 63/263,011, filed on Oct. 25, 2021.

(51) Int. Cl. G06F 21/62

(52) U.S. Cl. CPC G06F 21/6227; G06F 2221/2111

(57) ABSTRACT

This disclosure relates to, among other things, secure data rights management and governance. Certain embodiments disclosed herein provide for a data access control and management architecture that enforces one or more rules, restrictions, and/or configurations in connection with managing access requests to data. In various embodiments, one or more of the enforced rules, restrictions, and/or configurations may articulate access conditions that depend, at least in part, on a source, physical location, and/or an execution environment associated with a data access request. In this manner, data access may be managed and/or governed based, at least in part, on the source, location, system and/or associated environment requesting access to the data.

### RELATED APPLICATION

This application claims the benefit of priority under 35 U.S.C. § 119(e) to U.S. Provisional Patent Application No. 63/263,011, filed Oct. 25, 2021, and entitled “ENVIRONMENT BASED DATA ACCESS MANAGEMENT SYSTEMS AND METHODS,” the contents of which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for securely managing and/or otherwise controlling access to data. More specifically, but not exclusively, the present disclosure relates to systems and methods for managing data based, at least in part, on physical locations and/or execution environments associated with data access requests.

Enterprises generate and store a variety of data in connection with a number of applications and/or contexts. Enterprises may wish to ensure that such data is accessed in a secure, managed, and/or otherwise governable manner to ensure that only authorized actors are able to access and/or otherwise interact with data and/or that integrity of the data is maintained. In many conventional data management paradigms, access to data may be restricted and/or permitted based on the identity of a data requestor in accordance with one or more rules, restrictions, and/or configurations that may define which requestors and/or accessors are permitted access and which requestors and/or accessors should be denied access. For example, access control may be based on roles and/or access control lists where users are either given access to a data set and/or denied access to a data set based on assigned roles.

While such rules, restrictions, and/or configuration may manage data by users, systems, and/or entities based on authenticated identity, this paradigm may not necessarily prevent users who are granted access to data from copying it and storing it outside a data management and/or governance ecosystem and/or preventing access from outside authorized physical locations. Moreover, as the number of data sets and connectedness of the data sets increases, the number of roles may also increase, which can introduce significant complexity and data management challenges. In addition, many conventional data management platforms may not prevent a user from accessing data from outside secure environments and/or from unauthorized locations and/or from exporting data to which a user is allowed access outside authorized and/or otherwise secure environments.

For example, if a technician is called to repair an electrical problem in an electrical delivery and/or distribution network during a specific time period in a specific location and/or area, the technician should potentially be provided access to electric grid data around the area and/or relevant to the repair during the time of the repair, but may not necessarily be provided access to other data not relevant to the repair (e.g., data associated with other locations and/or outside the repair period). If the technician leaves the authorized location, a managing entity may wish to restrict that technician's access to data that they otherwise would have had access to had they remained at the authorized location. Similarly, in a further example, it may be desirable to share sensor data with a user in a smart city and/or other Internet of Things (“IoT”) environment, but only when the user is proximate to a physical location of the sensor. Smart devices may be deployed in a manner that facilitates communication and cooperation with other smart devices, but it may be desirable to limit this communication and/or associated data sharing to a subset of other connected devices (e.g., devices that are proximately located, devices of the same type, devices having the same manufacturer, and/or the like).

Embodiments of the disclosed systems and methods may manage access to data based on a source, location, and/or execution environment that originates a data access request in addition to authenticated identity. In some embodiments, one or more rules, restrictions, and/or configurations associated with data (e.g., data included in one or more data sets and/or originating from and/or otherwise generated by one or more data sources) may manage access to the data based, at least in part, on a location, source, and/or execution environment where a data access request is originating from. Among other things, this may help to ensure that data is not copied and/or otherwise made accessible outside a requesting system. For example, by allowing data access requests issued from a secure and/or otherwise protected execution environment, a data access service may be assured that copying and/or other protection mechanisms may be enforced based on protections offered by the secure environment restricting data import and/or export.

Further embodiments of the disclosed systems and methods may use graph and data-based rule systems where data access permissions may not necessarily be statically defined, but may be associated with dynamically defined rules that use relational data and/or information. For example, a first data set may comprise layout information relating to an energy delivery and/or distribution grid, a second data set may comprise work order information, and a third data set may comprise technician user data. Consistent with various embodiments disclosed herein, a data access security rule could be defined such that a user may be granted access to data that is related to a particular work order by a relation defined in one or more field values of the data sets and a graph structure providing associated connections between the data sets. Such a rule may take into account, for example and without limitation, spatial, temporal, and/or relational information from a data set graph and data values within the one or more data sets. Various embodiments disclosed herein may provide for dynamic rules that take into account a variety of attributes including, for example and without limitation, user attributes, physical location, secure execution environments, group attributes, and/or temporal constraints, in connection with rule and/or data access enforcement determinations.

### BRIEF DESCRIPTION OF THE DRAWINGS

The inventive body of work will be readily understood by referring to the following detailed description in conjunction with the accompanying drawings, in which:

FIG. 1 illustrates a non-limiting example of an architecture for managing data access consistent with certain embodiments disclosed herein.

FIG. 2 illustrates a flow chart of a non-limiting example of a method for managing data access based on an execution environment associated with a data access query consistent with certain embodiments disclosed herein.

FIG. 3 illustrates a flow chart of a non-limiting example of a method for managing data access based on a location associated with a data access query consistent with certain embodiments disclosed herein.

FIG. 4 illustrates a flow chart of a non-limiting example of a method for managing data access using identifiers consistent with certain embodiments disclosed herein.

FIG. 5 illustrates a conceptual diagram of a non-limiting example illustrating conceptual relationships between one or more organizations, groups, and/or users consistent with certain embodiments disclosed herein.

FIG. 6 illustrates a conceptual diagram of a non-limiting example of a directory tree and an associated rule set consistent with certain embodiments disclosed herein.

FIG. 7 illustrates an example of a system that may be used to implement certain embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide for a data management platform that facilitates secure data rights management and governance. In some embodiments, a data management service may enforce one or more rules, restrictions, and/or configurations in connection with managing access requests to data. Consistent with embodiments disclosed herein, one or more of the enforced rules, restrictions, and/or configurations may articulate access conditions that depend, at least in part, on a source, physical location, and/or an execution environment associated with a data access request. In this manner, data access may be managed and/or governed based, at least in part, on the source, location, system and/or associated environment requesting access to the data. Further embodiments may implement graph and data-based rule systems where data access permissions may be associated with dynamically defined rules that use relational data and/or information.

Data Access Control and Management Architecture

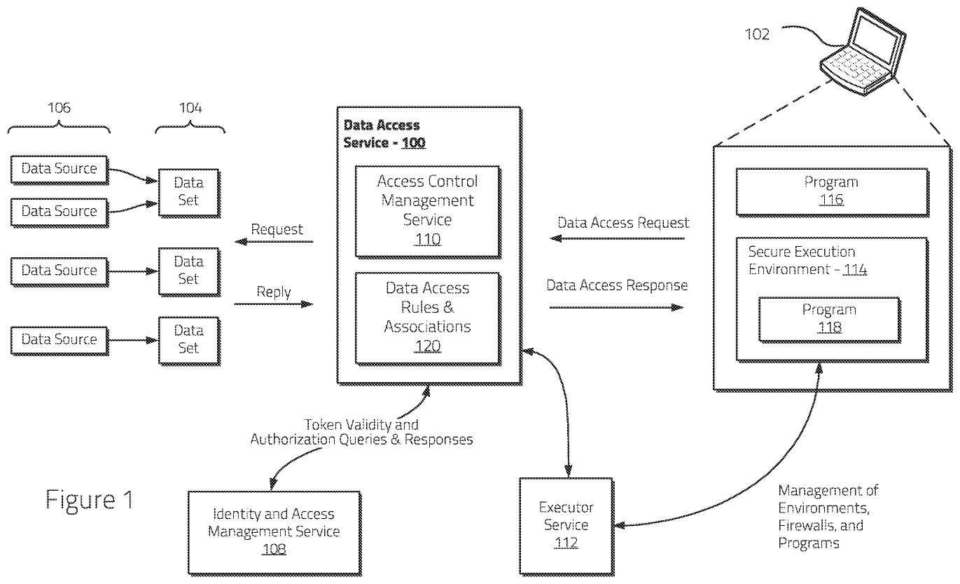

FIG. 1 illustrates a non-limiting overview example of an architecture for managing data access that includes a data access system and/or service 100, which may be generally referred to herein as a data access service, consistent with certain embodiments disclosed herein. The data access service 100 may be configured to receive, manage, and/or respond to data access requests issued by systems and/or programs (and/or users associated with such systems and/or programs), which may be generally referred to herein in certain instances as a querying system 102.

In some embodiments, the data access service 100 may comprise a service executing on a system different, separate, and/or otherwise remote from a querying system 102 issuing a data access request to the data access service 100. In further embodiments, the data access service 100 may execute on the same system as querying system 102 issuing a data access request to the data access service 100. In embodiments where the data access service 100 may execute on the same system as the querying system 102 issuing a request, the data access service 100 may in certain implementations be configured to execute in a separate and/or protected execution environment that is different from a program and/or executing environment originating the request on the same system.

Data access requests may specify one or more data sets 104 and/or subsets thereof managed, at least in part, by the data access service 100 associated with the requests. Data sets 104 may be associated with, obtained from, and/or otherwise generated by one or more data sources 106 and/or associated devices and/or systems. In some embodiments, a data set 104 may comprise data obtained from and/or generated by a plurality of data sources 106. In further embodiments, a data set 104 may comprise data obtained from and/or generated by a single data source 106. In various embodiments, a data set 104 may not necessarily comprise the subject data, but may comprise one or more references and/or pointers to locations where the subject data may be accessed (e.g., locations associated with the one or more associated data sources 106 and/or one or more other data sources and/or systems), as may be the case with a virtual data set.

In some embodiments, the data sets 104 and/or data sources 106 may be stored, managed, and/or otherwise associated with the same system implementing the data access service 100. In further embodiments, the data sets 104 and/or data sources 106 may be stored, managed, and/or otherwise associated with one or more systems separate from the system implementing the data access service 100 (e.g., systems associated with data sources 106 themselves and/or one or more intermediate systems, as discussed below).

In certain embodiments, data sets 104 may be accessed (e.g., in some cases, accessed directly) by the data access service 100 from one or more associated data sources 106 and/or associated systems. For example and without limitation, data relating to wind turbine electrical power generation may be accessed from a system associated with the wind turbine system. In further embodiments, data sets 104 may be accessed via one or more intermediate systems. For example and without limitation, data sets may be accessed by the data access service 100 from a data aggregation service configured to aggregate data from one or more data sources.

Consistent with embodiments disclosed herein, the data access service 100, may allow the querying system 102 to read and/or otherwise access data and/or subsets thereof from one or more data sets 104 (which in some embodiments may comprise a predefined set of data sets). In certain embodiments, various functionality of the data access service 100 and/or aspects thereof as described herein may be performed by an access control management service 110 executing on a system associated with the data access service 100.

In certain embodiments, the data access service 100 may check and/or otherwise enforce permissions on data access requests by interacting with an identity and access management (“TAM”) service 108. Among other things, the IAM service 108 may maintain a set of rules, conditions, and/or restrictions associated with accessing one or more data sets 104 from one or more users, and may validate the identity of a system, program, and/or user requesting access to a data set 104 and/or otherwise validate access rights and/or provide the data access service 100 with information used to manage access (e.g., restrictions that may be enforced by the data access service 100).

In certain embodiments, the querying system 102, user, and/or program may authenticate with the IAM service 108 and obtain identification information from the IAM service 108 which, in certain embodiments, may comprise a token. For example and without limitation, in some embodiments, a program of the querying system 102 may obtain a token bound to a session from the IAM service 108 that may be used in connection with validating and/or otherwise authorizing data access requests issued to the data access service 100.

Based on a data access request issued to the data access service 100, which may in some embodiments comprise identification information associated with querying system 102, user, and/or program executing on the querying system 102 (e.g., a token) and/or information relating to specific data to which access is being requested, the IAM service 108 may determine whether the querying system 102, user, and/or program is permitted access to the requested data based on one or more rules, conditions, and/or permissions information managed by the IAM service 108. The IAM service 108 may then forward a response to the data access service 100 granting, denying, and/or issuing restrictions in response to the request that may be enforced by the data access service 100.

For example and without limitation, in some embodiments, the data access service 100 may issue an authorization request to the IAM service 108 that includes identification information associated with a querying system 102, user, and/or program (e.g., a token issued by the IAM service 108) and/or information relating to specific data to which access is being requested. In response, the IAM service 108 may generate a response to the data access service 100 granting and/or denying the authorization request. In certain embodiments, the IAM service 108 may further include one or more restrictions in the response, which may be enforced by the data access service 100.

Consistent with embodiments disclosed herein, the data access service 100 may further consider a source location and/or executing environment associated with a request in determining whether to deny and/or allow a data access request issued by the querying system 102 based on one or more restrictions returned by the IAM service 108. In certain embodiments, the data access service 100 may manage access to data sets 104 based on information received as part of a data access request from a querying system 102 (which may comprise authentication credentials associated with the querying system 102, program, and/or an associated user such as an access token), available information about the request's origin (e.g., from within a secure execution environment (“SEE”) 114 of the querying system 108), and/or information received from the IAM service 108 in response to an access authorization request (e.g., authenticated location information associated with a token provided in connection with the access authorization request).

For example and without limitation, based on information received from the querying system 102, the data access service 100 may issue an access authorization query to the IAM service 108. The IAM service 108 may authenticate certain user identifiers, tokens, and/or other credentials included in the authorization query. The IAM service 108 may return information indicating whether the data access service 100 should deny or allow the request (potentially with an indication of associated access restrictions). If access restrictions are returned from the IAM service 108, the data access service 100 may enforce those restrictions in connection with managing access to requested data. For example, the data access service 100 may enforce restrictions returned by the IAM service 108 to manage access to data sets 104 based on a location and/or an execution environment of a system, program, and/or associated user that originates a data access request (e.g., querying system 102).

As illustrated, in various embodiments, the querying system 102 may comprise and/or otherwise be associated with one or more execution environments, which may comprise one or more open execution environments (e.g., an execution environment in which program 116 executes) and one or more SEEs 114 (e.g., a secure environment in which program 118 executes). For example, a program 118 associated with the querying system 102 requesting access to the data from the data access service 110 may execute in a controlled and/or otherwise protected SEE 114, which in certain instances herein may be referred to as a sandbox and/or a sandboxed environment. Another program 116 may execute in an open execution environment of the querying system 102.

In some embodiments, the SEE 114 may be managed, at least in part, by a firewall managing inbound and/or outgoing network connections. Programs executing within the SEE 114 (e.g., program 118) may be prevented by the environment from exporting certain data from within the environment by restricting outbound connections. Consequently, information retrieved inside the SEE 114 may remain within the protected environment. In further embodiments, access to and/or between other system resources and programs executing within the SEE 114 may be managed and/or otherwise restricted by the SEE 114. In this manner, the sandboxed SEE 114 may comprise an isolated and/or otherwise controlled environment in which the program 118 may execute, where certain data cannot be accessed outside the SEE 114 and/or exported outside the SEE 114 without permission.

In some embodiments, the SEE 114 may, for example and without limitation, comprise an environment that ensures that programs executing within the SEE 114 be run under a well-defined identity and/or in accordance with one or more other execution parameters and/or conditions. By validating that the program 118 initiating the request is executing within such a protected SEE 114 and/or the request originated from such an environment, the data access service 100 and/or IAM service 108 may be able to assure a level of trust relative to an identity associated with the request and/or parameters under which the request originated in addition to the originating source, location, and/or environment.

In certain embodiments, the data access service 100 may monitor multiple ports (e.g., transmission control protocol (“TCP”) ports) for requests to determine an environment from which the request is received. For example, in some embodiments, a first port may be used for “external” requests— that is, requests that do not originate from within the SEE 114. For example, program 116 executing within an open environment of the querying system 102 may issue data access requests to the data access service 102 via the first port. A second port may be used for requests issuing from the sandboxed SEE 114. For example, program 118 executing within the SEE of the querying system 102 may issue data access requests to the data access service via the second port. In some embodiments, the ports associated with data access requests originating within the SEE 114 may not be accessible to programs outside the SEE 114. That is, unless a requesting program is running inside the SEE 114, it may not access the port dedicated for SEE sandbox requests.

Using this mechanism, the data access service 100 may determine whether a request is originating from within the SEE 114 or not based on which port the request was received. The determination by the data access service 100 whether the origin of the request originated from within the SEE 114 may be used to allow, deny, and/or otherwise restrict access responsive to a request consistent with embodiments disclosed herein.

As discussed above, in connection with an authorization response issued to the data access service 100 by the IAM service 108, the data access service 100 may receive one or more rules, restrictions, and/or conditions associated with accessing the requested data from the IAM service 108. In certain embodiments, such access rules, restrictions, and/or conditions may reference a location restriction. In certain embodiments, such a location restriction may comprise a restriction relating to a system and/or associated execution environment associated with a data access request, which may be conceptually viewed as an electronic location of an originating data access request. In further embodiments, a location restriction may comprise a restriction relating to a physical and/or otherwise geographic location associated with a data access request. Data access restrictions, including location restrictions, may be enforced by the data access service 100, which may store and/or otherwise cache certain data access restrictions and/or other information 120 locally for future lookup without having to re-query the IAM service 108 for access authorization determinations.

For example and without limitation, a data access request may be received from a program 116 executing outside the SEE 114 via a public port of the data access service 100. In response, the data access service 100 may make an access authorization request to the IAM service 108, which may return whether the request should be allowed or denied and, if allowed, any restrictions which should be enforced (e.g., based on identity information included in the data access request associated with the querying system 102, the program 116, an associated user, etc.). In the case of a location restricted rule, the restriction may include an indication that the origin of a request should be from within the SEE 114.

The data access service 110 may examine the response received from the IAM service 108 and determine whether the data access request should be allowed or denied and/or otherwise enforce the location restriction. In the above example, the data access service 100 may determine that the request was issued over the public port (e.g., the non-SEE port), and thus that the origin of the request with not within the SEE 114. Based on this determination, the data access service 100 may restrict access in accordance with execution environment location restrictions returned by the IAM service 108. If the origin of the data access request is within the SEE 114 (e.g., from program 118), which may be determined by checking the port over which the request came, it may allow access to the requested data, potentially applying any restrictions to such access if applicable.

Further embodiments disclosed herein may implement a physical and/or otherwise geographic location access restrictions in connection with a data access request. As detailed above, in certain embodiments, a data access request issued by the querying system 102 to the data access service 100 may comprise certain information identifying the system, a program, and/or an associated user (e.g., a user ID, a source ID, and/or the like). In certain embodiments, an access token may be generated by the IAM service 108 and issued to the querying system 102 and/or an associated program and/or user after authenticating certain user, system, program, and/or API key credentials. In some embodiments, the value of the access token may be a random byte string that cannot readily be forged.

Consistent with various embodiments disclosed herein, trusted physical and/or geographic location information may be validated during an authentication process between the querying system 102 and the IAM service 108 and associated with a session. For example and without limitation, WebAuthn (FIDO2) authentication may be used to determine GPS coordinate data associated with a querying system 102. This information may be considered authenticated location information under the authentication protocol. A token issued to the querying system 102 as part of the authentication process with the IAM service 108 may be associated with the authenticated geographic location, which may be later validated and/or otherwise be determined by querying the IAM service 108 with the token.

For example and without limitation, during authentication with the IAM service 108, geographic location information may be captured and bound to a session and/or associated with a token and/or other authenticated identification information associated with a querying system 102. This authenticated location information can be used by the data access service 100 in connection with authorizing a data access query and/or enforcing restrictions in access rules.

In yet further embodiments, determining a source location and/or executing environment associated with a request may involve a source determination on a network level. For example, in some embodiments, an internet protocol (“IP”) address associated with an execution environment (e.g., a controlled and/or other SEE 114 of the querying system 102) issuing a request may be used to identify the source, location, and/or execution environment originating the request. As illustrated, in some embodiments, an executor service 112 may register an IP address associated with the querying system 102 and/or an associated SEE 114. The data access service 100 and/or the IAM service 108 may issue source address validation requests and receive associated responses from the executor service 112. By comparing an IP address associated with a received data access request from the querying system with one or more registered IP addresses, it may be determined whether the request is originating from a known system and/or execution environment (e.g., querying system 102 and/or SEE 114) registered by the executor service 112.

In various disclosed embodiments, an executor service 112 may be configured to establish and/or manage a secure, controlled, and/or otherwise isolated execution environment (e.g., SEE 114) of the querying system 102. In certain embodiments, the secure, controlled, and/or otherwise isolated execution environment may run on a different service and/or system that may be managed, at least in part, by the executor service 112. Similarly, consistent with certain embodiments disclosed herein, the executor service 112 may execute on a system distinct from the data access service 100 and/or the IAM service 108. The SEE 114 may, in some implementations, be associated with a system separate from the data access service 100 and/or the IAM service 108.

Although illustrated as separate services, it will be appreciated that the data access service 100 and the IAM service 108 may be implemented by a single system and/or service and/or by any suitable combination of systems and/or services. For example, in some embodiments, identity and/or environment-based validation consistent with various aspects of the disclosed systems and methods may be performed by a data access service 100.

Moreover, it will be appreciated that various embodiments of location-based restrictions disclosed herein may be combined in a variety of suitable data access management paradigms. For example, in certain embodiments, execution environment restrictions may be used in conjunction with geographic location restrictions in connection with data access management determinations. Therefore, it will be appreciated that the specific architecture and interactions illustrated and described in connection with FIG. 1 are presented for purposes of illustration and explanation rather than limitation.

Data Access Management Based on Execution Environment(s) Associated with Data Access Requests

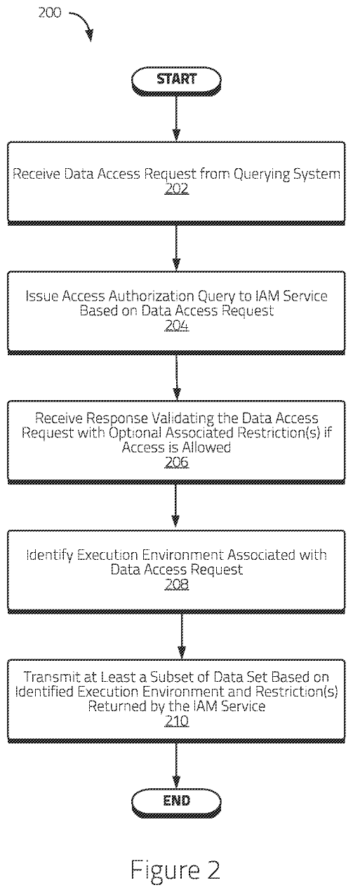

FIG. 2 illustrates a flow chart of a non-limiting example of a method 200 for managing data access based on an execution environment associated with a data access query consistent with certain embodiments disclosed herein. The illustrated method 200 may be implemented in a variety of ways, including using software, firmware, hardware, and/or any combination thereof. In certain embodiments, various aspects of the illustrated method 200 and/or its constituent steps may be performed by a data access service and/or any other suitable device, system, and/or service and/or combination of devices, systems, and/or services.

At 202, the data access service may receive a data access request from a querying system. The data access request may comprise, for example and without limitation, identification information associated with the request and/or an indication of a requested data set managed by the data access service system. In certain embodiments, the identification information may comprise information associated with the querying system, a user of the querying system, a program and/or application executing on the querying system. As discussed in more detail below, in certain embodiments, the data access service may, based on the manner in which the data access request was received, be able to determine an execution environment of the querying system from which the data access request originated. In some embodiments, the identification information may comprise an access token (e.g., a WebAuthn access token and/or the like).

In some embodiments, the identification information associated with the request may not necessarily directly convey identifying information, but may comprise information that may be used to retrieve and/or otherwise access identifying information. For example, the data access request may comprise an access token. The access token may not itself directly convey identifying information, but may be used by the data access service to retrieve identification information in connection with a validation and/or authorization request issued to the IAM service.

The data set may comprise a data set managed and/or otherwise stored by the data access service. In further embodiments, the data set may comprise data stored by one or more other database services and/or systems that is managed by the data access service. In certain embodiments, the data set may comprise a virtual data set.

The data access service may issue an access authorization query to an IAM service at 204 based on the data access request. In certain embodiments, the authorization query may comprise the identification information, which may include a token (e.g., an access token issued to the querying system 102 and/or an associated program and/or user by the IAM service), the indication of the requested data set, and/or requested operations (e.g., query, delete, update, etc.). At 206, the IAM service may return an authorization response validating the identification information (or not validating the information if applicable) along with any associated restrictions associated with accessing the data set. For example, in various embodiments, the IAM service may return an authorization response indicating whether the data access request should be denied and/or allowed and, if allowed, what restrictions should be enforced by the data access service. In some embodiments, information included in the authorization response may be cached and/or otherwise stored by the data access service for future quick lookups.

In certain embodiments, multiple queries may be made to the IAM service by the data access service. For example, in some embodiments, the authorization query and/or authorization response between the IAM service and the data access service described herein may comprise multiple and/or a series of queries and/or responses issued between the IAM service and/or the data access service. In at least one non-limiting example, a data access service may first validate a token. For example, the data access service may first (optionally) check a cache to determine whether the token has been previously validated and, if so, that the cached information has not expired. If the token has not been validated in cache (or if a cache check is not performed in an implementation), the data access service may query the IAM service with the access token to validate the token. A token validation response may be returned by the IAM service indicating whether a token is current or expired, potential with identity information associated with the token and/or authenticated associated location information.

The data access service may then issue a request to the IAM service to determine whether an identity associated with the validated token has appropriate access rights to a specified data set. The IAM service may return an indication as to whether the user is allowed or not allowed the specific access and, if allowed, an indication of any applicable restrictions (which may include location restrictions). In this manner, it will be appreciated that the authorization query and associated response issued between the data access service and the IAM service as described generally herein may be implemented in a variety of ways and/or achieved through any suitable number of constituent query and/or response interactions between the services.

At 208, an execution environment of the querying system associated with the data access request may be identified. Consistent with embodiments disclosed herein, the execution environment of the querying system may be identified based on which port of a plurality of ports of the data access service the data access request was received. For example, in some embodiments, a first port may be used for “external” requests — that is, requests that do not originate from within a SEE of the querying system. A program executing within an open environment of the querying system may issue data access requests to the data access service via this first port. A second port may be used for requests issuing from the sandboxed SEE of the querying system. For example, a program executing within an SEE of the querying system may issue data access requests to the data access service via the second port. Using this mechanism, the data access service may identify an execution environment associated with the data access request based on which port the request was received.

Based on the identified execution environment and any restriction(s) returned from the IAM service, the data access service may transmit at least a subset of the requested data set to the querying system at 210 after enforcing the restriction(s). For example, consistent with any applicable restriction(s), the data access service may filter the data set and transfer the filtered data to the querying system. In certain circumstances, if access is restricted and/or denied, the data access service may return a null set and/or another indication of denied access to the querying system.

Data Access Management Based on Physical Location(s) Associated with Data Access Requests

Consistent with certain embodiments disclosed herein, trusted authenticator services (e.g., WebAuthn services) may be used to provide a trusted indication of physical location associated with a request. In some embodiments, a data access service may receive a token from a querying system as part of a data access request issued to the querying system as part of a trusted authentication process such as WebAuthn. In certain embodiments, the IAM service may determine whether to accept an inbound authenticator and/or what information should be included in an associated session generated through the authentication process with the IAM service (e.g., trusted physical location information).

Certain authenticators may be equipped to provide both user authentication and authenticated location data using a location extension. Further authenticators may be trusted to only provide user authentication information. The IAM service system may reference one or more managed policies to determine whether to associate location information with authentication request based on evaluating a level of trust associated with a particular authenticator.

In certain embodiments, an IAM service can flag a trust level associated with a source, and subsequently rules and/or restrictions can be applied with knowledge of the trust level associated with the location information. For example, an IAM service may bind trusted attributes (e.g., trusted location) to an authenticated session, potentially with an indication of an associated trust level, thereby associating these trusted attributes with an access token. In this manner, certain data may only be accessed through the data access service where location data corresponding to a data access request is sourced from a trusted GPS aware authenticator that can be cryptographically verified to have originated from such a trusted authenticator and/or an authenticator with a certain level of trust.

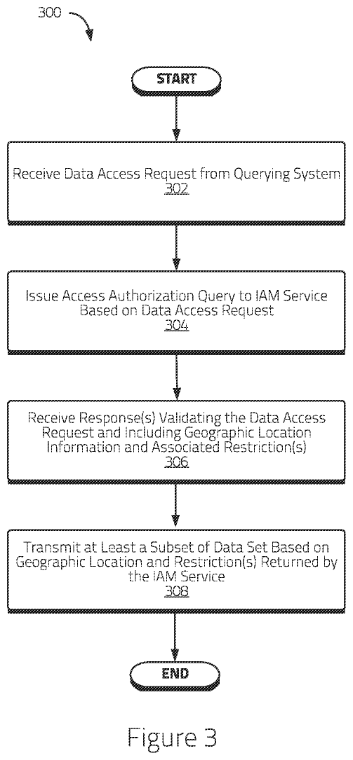

FIG. 3 illustrates a flow chart of a non-limiting example of a method 300 for managing data access based on a location associated with a data access query consistent with certain embodiments disclosed herein. The illustrated method 300 may be implemented in a variety of ways, including using software, firmware, hardware, and/or any combination thereof. In certain embodiments, various aspects of the illustrated method 300 and/or its constituent steps may be performed by a data access service and/or any other suitable device, system, and/or service and/or combination of devices, systems, and/or services.

At 302, the data access service may receive a data access request from a querying system. The data access request may comprise, for example and without limitation, identification information associated with the request and/or an indication of a requested data set managed by the data access service system. In certain embodiments, the identification information may comprise information associated with the querying system, a user of the querying system, a program and/or application executing on the querying system, and/or an execution environment of the querying system from which the data access request originated. In some embodiments, the identification information may comprise an access token (e.g., a WebAuthn access token and/or the like).

In certain embodiments, the identification information associated with the request may not necessarily directly convey identifying information, but may comprise information that may be used to retrieve and/or otherwise access identifying information. For example, the data access request may comprise an access token. The access token may not itself directly convey identifying information, but may be used by the data access service to retrieve identification information in connection with a validation and/or authorization request issued to the IAM service.

The data set may comprise a data set managed and/or otherwise stored by the data access service. In further embodiments, the data set may comprise data stored by one or more other database services and/or systems that is managed by the data access service. In certain embodiments, the data set may comprise a virtual data set.

The data access service may issue an authorization query to an IAM service based on the data access request at 304. Although described herein generally as an authorization query, it will be appreciated that such an authorization query may comprise a multiple queries made to the IAM service by the data access service, which may include token validation and/or access authorization queries. In certain embodiments, the authorization query may comprise the identification information and the indication of the requested data set. At 306, the IAM service may return an indication validating the identification information (or returning an error if applicable), geographic location information associated with the access request, and/or any associated restrictions associating with accessing the data set. In some embodiments, the geographic location information may comprise a geographic location associated with the querying system, querying system user, and/or an associated account.

As discussed above, in certain embodiments, multiple queries may be made to the IAM service by the data access service. For example, in some embodiments, the authorization query and/or authorization response between the IAM service and the data access service described herein may comprise multiple and/or a series of queries and/or responses issued between the IAM service and/or the data access service. In at least one non-limiting example, a data access service may first validate a received token. For example, in some embodiments, having received a data access request from the querying system, the data access service may first (optionally) check a cache to determine whether the token has been previously validated and/or that the cached information has not expired. If the token has not been validated in cache (or if a cache check is not performed in an implementation), the data access service may query the IAM service with the access token to validate the token. A token validation response may be returned by the IAM service indicating whether a token is current or expired, potential with identity information associated with the token and/or authenticated associated location information.

The data access service may then issue an authorization access check request to the IAM service to determine whether an identity associated with the validated token has appropriate access rights to a specified data set. The IAM service may return an indication as to whether the user is allowed or not allowed the specific access and, if allowed, an indication of any applicable restrictions (which may include geographic location restrictions). In this manner, it will be appreciated that the authorization query and associated response issued between the data access service and the IAM service as described generally herein may be implemented in a variety of ways and/or achieved through any suitable number of constituent query and/or response interactions between the services.

Based on the geographic location and any restriction(s) returned from the IAM service, the data access service may transmit at least a subset of the requested data set to the querying system at 308 after enforcing the restriction(s). For example, consistent with any applicable restriction(s), the data access service may filter the data set and transfer the filtered data to the querying system. In certain circumstances, if access is restricted and/or denied, the data access service may return a null set and/or another indication of denied access to the querying system.

Data Access Management Based on Identifiers Associated with Data Access Requests

As detailed herein, various identifiers associated with a user, a querying system, a querying program, and/or an associated account may be used in connection with a variety of data access management and/or associated authorization and/or rule and/or restriction enforcement processes in connection with the disclosed embodiments. In some embodiments, identifiers associated with a source of a data access request may be used in connection with data access authorization and enforcing restrictions associated with location consistent with embodiments disclosed herein.

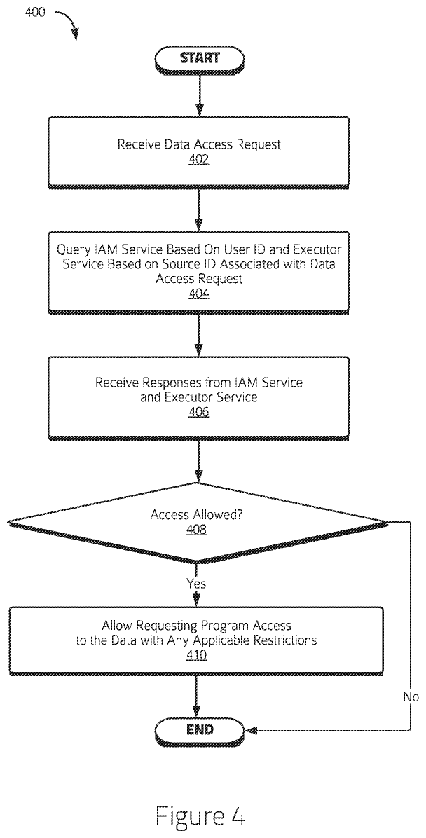

FIG. 4 illustrates a flow chart of a non-limiting example of a method 400 for managing data access using identifiers consistent with certain embodiments disclosed herein. In certain embodiments, the method 400 may use user and/or source identifiers in connection with data access authorization and/or restriction enforcement determinations by the data access service. The illustrated method 400 may be implemented in a variety of ways, including using software, firmware, hardware, and/or any combination thereof. In certain embodiments, various aspects of the illustrated method 400 and/or its constituent steps may be performed by a data access service and/or any other suitable device, system, and/or service and/or combination of devices, systems, and/or services.

At 402, a data access request may be received by a data access service. The data access request may comprise, for example and without limitation, one or more of an identity associated with a request user, system, and/or program issuing the request (which may be generally referenced as a “user ID” in connection with FIG. 4), information relating to a source and/or location of the requesting system and/or an execution environment of the requesting system (which may be referred to as a “source ID” in connection with FIG. 4), and/or information relating to the data that is the subject to the data access request.

A variety of information may be used for the user ID and/or the source ID. For example, in some embodiments, the user ID and the source ID may comprise one or more identification tokens. In some embodiments, a user ID token may be cryptographically and/or otherwise securely associated with a requesting user, system, and/or program. Similarly, a source ID token may be cryptographically and/or otherwise securely associated with a source and/or location of the requesting system, an execution environment of the requesting system, and/or the program originating the request. In further embodiments, the source ID may comprise IP address information associated with a source, location, and/or execution environment of the requesting system.

Based on the data access request, the data access service may query one or more services at 404 to determine whether to grant access to the data in response to the request. For example, in some embodiments, the data access service may query an IAM service to determine whether the requesting system, user, and/or program executing on the requesting system is associated with an identity permitted access to the requested data based, at least in part, on the user ID. A response to the access authorization query may be received at 406 which, in some embodiments, may comprise one or more applicable rules and/or restrictions.

At 408, based on the received authorization response, it may be determined whether the requested access is allowed and/or otherwise been authorized. If access is allowed, the data access service may permit access to the requested data at 410, potentially enforcing any applicable rules and/or restrictions.

Access Control Rules and/or Restrictions

In various embodiments, data access management services may identify and/or otherwise enforce one or more rules, conditions, and/or restrictions associated with the access of one or more data sets. In some implementations, a rule may be associated with a data set that defines various rules, conditions, and/or restrictions associated with accessing the data set. Consistent with embodiments disclosed herein, one or more of the enforced rules, restrictions, and/or conditions may implement graph and data-based rule systems where data access permissions may be associated with dynamically defined rules that use relational data and/or information.

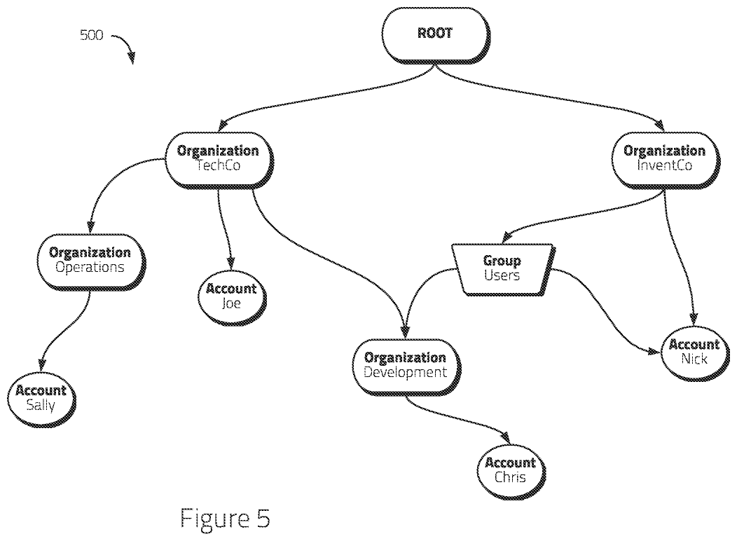

FIG. 5 illustrates a conceptual diagram 500 of non-limiting example illustrating conceptual relationships between one or more organizations, groups, and/or users consistent with certain embodiments disclosed herein. As discussed above, in various embodiments of disclosed systems and methods, data access rules may be defined that may be used in connection with a directory that includes objects for performing access control consistent with embodiments disclosed herein. The directory may include subjects and their relationship to other subjects, as well as objects (e.g., data sets) and/or privileges. In certain embodiments, dynamically defined rules may be used in connection with relational data and/or other information included in a directory. Such rules may take into account, for example and without limitation, spatial, geographical, temporal, and/or relational information from a data set graph and data values within the one or more data sets. For example and without limitation, a rule may, via one or more articulated restrictions, specify that data may be accessed by a specified subject (e.g., associated with a specified execution environment) located at a specified physical location within a specified time period.

Consistent with certain disclosed embodiments, a restriction may define one or more objects the restriction is specified for. This may comprise one or more indications of subjects, objects, privileges, and/or restrictions. A subject may comprise one or more identities. For example and without limitation, a subject may comprise an indication of one or more users, groups, and/or organizations. An object may comprise one or more objects that a rule applies to, which may be any object known the systems and/or service and/or associated with the rule definition paradigm.

Various related logical entities representing subjects may also have associated relationships, which in certain embodiments may be hierarchical in nature. For example, an organization may be associated with one or more constituent groups. A group may be associated with one or more constituent users. Organizations, groups, and/or users may be associated and/or related as appropriate. In addition, organizations, groups, and/or users may be associated with one or more locations, data sets, devices, and/or the like.

In certain embodiments, subjects may comprise, accounts, organizations, and/or groups. Accounts may comprise an account associated with a user, which may be a human user and/or a non-human user (e.g., a program). Organizations may represent a hierarchical tree of accounts, sub-organizations, and/or other objects. In certain implementations, each account may be a member of at least one organization. Groups may comprise a list of accounts, organizations, and/or other groups, which may be considered a member of the group. Members of a group can span multiple organizations. An account may be considered a member of a group if it is either explicitly named (e.g., directly) or is indirectly referenced by organizations and/or groups to which the account directly and/or indirectly belongs.

As illustrated in FIG. 5, organizations (e.g., TechCo, InventCo, etc.) may be subordinate to a root within the hierarchy. Organizations may have one or more child organizations. In the illustrated example, Operations and Development may be child organizations of TechCo. Accounts may be child objects to organizations and/or groups. Groups may be subordinate to organizations (e.g., through parent and/or child relationships in the hierarchy) and/or accounts. In the illustrated example, the group Users may be child of InventCo, the organization Development may be a child of the group Users, and the account Nick may be associated with both the Group users and the organization InventCo (potentially directly as shown or via an intermediary relationship such as via the group Users).

Various embodiments disclosed herein may use an “account” in connection with access control, management, and/or access management decisions. Consistent with embodiments disclosed herein, an account may be a subject that may be authenticatable and/or make API calls to various services. In some embodiments, from an access control perspective based on articulated rules and/or restrictions, subjects may comprise accounts, organizations, and/or groups. Access may be granted, however, to an account based on any organizations or groups an account is a member of

Accounts may be identifiable and authenticated. An account may be authenticated (e.g., via authentication queries issued to an IAM service) using user credentials and/or API key credentials. User credentials may be used by human users and API key credentials may be used for non-human users such as programs, devices with securely associated API keys, and/or the like (e.g., wind turbine systems, IoT devices, etc.).

In some embodiments, an account's authenticated session may be tagged and/or otherwise associated with a location denoting a geographic location of a user and/or device associated with the account. In certain embodiments (e.g., implementations that support WebAuthn), a querying device providing authentication credentials may have certain geographic location capabilities such as, for example and without limitation, GPS capabilities. An authentication specification may allow for a location extension, whereby the GPS coordinates of the authenticating device may be sent to an authentication service along with other authentication information. If for example, a user uses WebAuthn to authenticate with an associated IAM service, GPS location information (e.g., latitude and/or longitude coordinates) may be captured and saved in a session associated with an access token issued to the user. This access token may then be used to determine a location associated with the user account in connection with enforcing restrictions consistent with various disclosed embodiments. For example, a querying device may be issued an access token that it may use to authenticate access to other services (e.g., the data access service). The access token may be associated with location information which can be used by the data access service in connection with enforcing restrictions consistent with embodiments disclosed herein.

In at least one non-limiting example, a user may authenticate with an IAM service using WebAuthn implementing a location extension. An access token bound to the account may be associated with GPS coordinates associated with the authenticated session for the account. Over time, the user may move and/or change location. Consistent with embodiments disclosed herein, the freshness of location data may be considered and/or enforced in restrictions. For example and without limitation, when enforced restrictions consider an account's location (e.g., $account.location in restrictions), they may also take into account the account's location freshness (e.g., $account.locationFreshness in restrictions). A restriction may wish to not trust the location information beyond some time interval. In certain embodiments reauthenticating access tokens after expiration may bind new fresh location data to a session.

In certain embodiments, rather than access restrictions articulating GPS coordinates, implementations may support higher level notions of location that the GPS coordinates may map to (e.g., city, count, house, block, state, country, continent, distance from a reference point, geographic polygon, and/or the like). Non-limiting illustrative examples of access restrictions implementing such a higher-level notion of location include:

JOE can QUERY this DATA SET if $account.location.city=“San Francisco”

JANE can QUERY this DATA SET if distance_from ($account.location.coordinates, <50 miles).

A rule may be associated with one or more privileges. In some embodiments, privileges may be defined relatively flexibly and/or may be interpreted by an application as appropriate. In certain embodiments, system defined privileges may be applied by the system, potentially automatically. System defined privileges may comprise, for example and without limitation, privileges relating to object and/or data visibility, privileges relating to the ability to add, modify, delete, and/or otherwise change objects and/or rules, and/or the like.

Restrictions may comprise a specification of further limitations within an object. For example, in the case of a data set object, a restriction may allow restriction of the visibility of data within a data set by applying restrictions to the visible columns of data or rows of data. In some embodiments, restrictions may contain static limitations and/or dynamic limitations. Dynamic limitations can, for example and without limitation, be read from a user, group(s), and/or organizations of the requester. As data sets can be comprised of joins between multiple database tables, the combination of dynamic data in restrictions and table joins in the data set can be used to achieve dynamic permissions that use data from multiple sources.

In some embodiments, a rule may specify a subject, privilege, an allow/deny flag, an object (e.g., a specified data set), and/or a depth). The subject may specify what account, organization, and/or group the rule is targeted to. The privilege may specify the operation granted or denied to the subject. The allow/deny flag may indicate whether the rule grants or denies the privilege. The object may specify what object is being governed. And the depth indication may allow for the governance to extend in the directory hierarchy below the specified object, so as to govern a range of objects. A depth of 0 may indicate “only this object”, while a depth of 1 may indicate “this object and its immediate children”, and a depth of −1 may indicate “this object and all its descendent objects”. Non-limiting examples of relatively simple rules are provided below:

| | | Allow/ | | |
|---|---|---|---|---|
| Subject | Privilege | Deny | Object | Depth |
| Joe | sys:catalog:query-data | Allow | Data Set 1 | 0 |
| (Account) | | | (Data set) | |
| TechCo | sys:catalog:query-data | Deny | Data Set 2 | 0 |
| (Organization) | | | (Data set) | |
| Admins | sys:catalog:privileged- | Allow | Data Set 1 | 0 |
| (Group) | read-access | | (Data set) | |

The second rule above, for example, may deny the sys:catalog:query-data privilege to all members of the TechCo organization on the data set having an ID Data Set 2.

Consistent with embodiments disclosed herein, rules may have additional fields articulating restrictions and/or restriction combinator (“RC”), which may allow for combining restrictions from multiple applicable rules. A non-limiting example of a more dynamic rule with restriction information is provided below:

| Subject | Privilege | Allow/Deny | Object | Depth | Restriction | RC |
|---|---|---|---|---|---|---|
| Joe | sys:catalog:query-data | Allow | Data Set 1 | 0 | (Examples below) | AND |

Articulated restrictions in the restriction field of the rule may include, for example and without limitation, restrictions such as:
QueryRows(CUSTOMERID>10000 and $time.hour>10 and $time.hour<=11)
   Returns rows where CUSTOMERID column value is >10000 between the hours of 10:00 and 11:00.
QueryRows(mgr_id=$subject.attributes[‘EMPLOYEE_CD’])
   Returns rows where mgr_id column value matches the EMPLOYEE_CD attribute on the subject. These attributes may be stored as read-only properties in the subject's account object.
QueryRows(state=$subject.location.state)
   Returns rows state column value matches the state of the subject's location, assuming that the location has been captured during authentication using a client device capable of capturing this information.

It will be appreciated that rules and restrictions may take a variety of forms. As such, the examples of rules and/or restrictions included herein are presented for purposes of illustration and explanation rather than limitation.

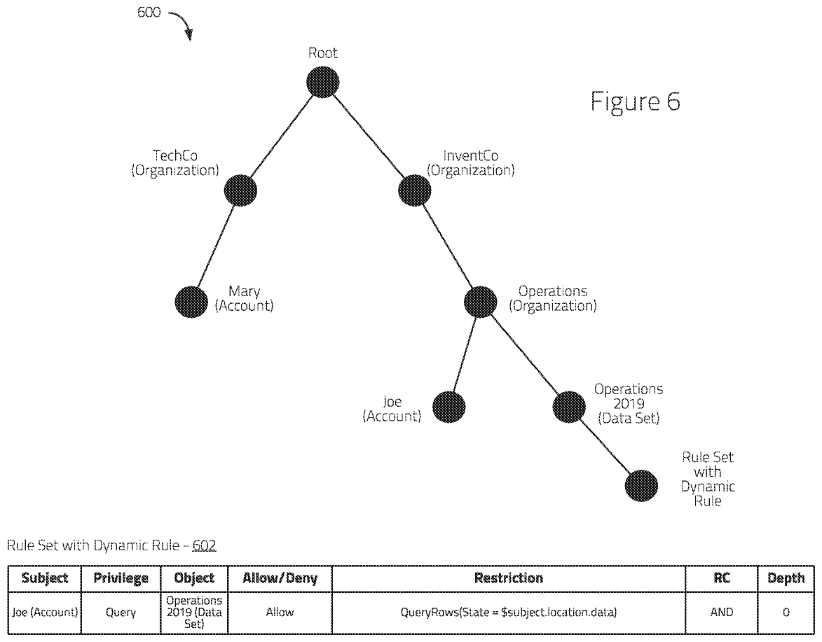

FIG. 6 illustrates a conceptual diagram of a non-limiting example of a directory tree 600 and an associated rule set consistent with certain embodiments disclosed herein. Two organizations—TechCo and InventCo—may be subordinate to a root. Mary may be an account under TechCo. InventCo may have a sub-organization Operations. Joe may be an account under Operations. Data set Operations 2019 may be attached to the Operations organization. A rule set 602 may attach to Operations 2019. The rule set 602 may define a restriction that allows rows containing a “state” column to be returned if a geographic location associated with a querying account is within the same state. GPS coordinates associated with the subject (e.g., coordinates captured during authentication) may be used to determine which state the user is located in, and the value of the determined state may be compared with the “state” column value. When enforced by a data access service, the rule set 602 may, for example, allow permitted users to query the Operations 2019 data set if their authenticatable location is within the same state as the “state” column value of the rule set 602.

It will be appreciated that a variety of logical entities and/or elements and/or associated relationships may be reflected and/or other included in an access control rule architecture and/or an associated use graph and data-based rule system, and that any suitable entities, elements, and/or relationships may be employed. In this manner, the specific architecture and relationships in connection with FIG. 5 and FIG. 6 are presented for purposes of illustration and explanation rather than limitation.

Access Control Restrictions Examples

Rules and/or restrictions may take a variety of forms and be used to enforce a variety of rules, conditions, and/or restrictions in connection with data access requests. Various non-limiting examples of restrictions are provided below. It will be appreciated, however, that restrictions may take a variety of forms and express a variety of rules, conditions, and/or restrictions, and therefore that the examples provided below are presented for purposes of illustration and explanation rather than limitation.

Example: QueryRows(CUSTOMERID>10000 and $time.hour>10 and $time.hour<=11).

This restriction may return rows where CUSTOMERID column value is>10000 between the hours of 10:00 and 11:00. This is an example of a time-based restriction.

Example: QueryRows(mgr_id=$subject.attributes[‘EMPLOYEE_CD’])

This restriction may return rows where mgr_id column value matches the EMPLOYEE_CD attribute on the subject. These attributes may be stored as read-only properties in the subject's account object. This is an example of limiting rows returned from a data set to instances where a specific column value matches an attribute that has been added to a user's account object (that is, the account associated with the one making the data access query).

Example: QueryRows(state=$subject.location.state)

This restriction may return rows where the state column value matches the state of the subject's location, assuming that the location has been captured during authentication using a client device capable of capturing this information. If no location information is available, access may be denied.

Example: QueryRows(age>20 AND GEO_Distance($subject.location, GPS(−37, 121), “miles”)<100)

This restriction may articulate “return all rows where column “age” has a value>20 AND the distance from the user's current location to GPS coordinate −37,121, is less than 100 miles.

Example: QueryRows(GEO_Within($subject.location, GetPoly(factory)))

This restriction articulates to return all rows where the subject's location (e.g., expressed in GPS coordinates) lies within the polygon defined by the rows' factory column's location. In some embodiments, a database may be used along with associated mapping procedures that can take a name of a factory or other location and identify an associated polygon from a table. A function may return true if the subject's location is within the identified polygon.

Example: QueryRows(state=$subject.location.state AND $subject.location.freshness<10)

This restriction may return rows matching a state in which the subject was located at the time of authentication, but only if that location information is less than 10 minutes old. For example, since a subject may be moving away from the place where the authentication was performed (e.g., the user's mobile phone's GPS coordinates at the time of authentication indicated he/she was at LOCATION1, but since that time, he/she has moved to LOCATION2), it may be advisable to record when the time at which the location was determined (e.g., freshness of location) and use that in a restriction.

Example: Access to data associated with a given location (e.g., a municipality) may be based on a subject's membership in a group. For example, there may be a group object called “Inchenhofen” and those subjects who are allowed to see energy data for the Inchenhofen municipality may be added as members of the Inchenhofen group. Each group may be tagged with a municipality ID. In at least one non-limiting example, a query restriction might read like this:

SelectRows(muni_id member of $subject.group_attributes[‘2f2297fe-e830-4d13-b143-be3485458c85’][‘urn:comfoo.municipality:id’])

This restriction may select all rows where the user is a member of a group whose municipality ID matches the column value muni_id. The UUID (2f2297fe-e830-4d13-b143-be3485458c85) may be an ancestor ID (e.g., of an organization) to limit the groups searched to those that are descendants of that ancestor ID. This may, among other things, enhance security by preventing bad actors from creating groups and adding the municipality ID attribute to the “bad” group, thereby allowing the subject to see rows associated with that municipality. The ‘urn:com.foo.municipality:id’ may be the ID of an attribute that is expected to be found on the group that names the municipality ID. In this case, a list of groups to which the subject (e.g., the subject making the call) is a member may be formed that are descendants of the organization whose ancestor ID is given. It may then be determined where any of those groups has the municipality ID in question (e.g., from the row/column value) as its ‘urn:com.foo.municipality:id’ attribute value.

In at least one non-limiting example, a Backus normal form (“BNF”) syntax for restriction definition may be expressed as:

{restriction} ::= {conjunction2}
{restriction} ::= ({conjunction2}, ..., {conjunction2})
{conjunction2} ::= {disjunction}
{conjunction2} ::= {disjunction} OR ... OR {disjunction}
{disjunction} ::= {conjunction}
{disjunction} ::= {conjunction} OR ... OR {conjunction}
{conjunction} ::= {atom}
{conjunction} ::= {atom} AND ... AND {atom}
{atom} ::= {predicate}({term}, ...)
{atom} ::= NOT {predicate}({term}, ...)
{term} := {function}({term}, ...)
{term} := {identifier}
{term} := {literal}
{predicate} := {identifier}
{function} := {identifier}

In a non-limiting example, semantics of restrictions may be of the form:
{term}—an arbitrary SQL expression
{predicate}({term}_1, {term}_2)—atom with predicate {predicate} with argument terms {term}_1 and {term}_2
NOT {predicate}( . . . )—negation (logical NOT) of predicate {predicate}
{atom}_1 AND {atom}_2—conjunction (logical AND) of atoms {atom}_1 and {atom}_2
{conjunction}_1 OR {conjunction}_2—disjunction (logical OR) of conjunctions {conjunction}_1 and {conjunction}_2
{disjunction}_1 AND {disjunction}_2—second-level conjunction (logical AND) of disjunctions {disjunction}_1 and {disjunction}_2
({conjunction2}_1, {conjunction2}_2)—second-level disjunction (logical OR) of second level conjunctions {conjunction2}_1 and {conjunction2}_2

Non-limiting examples of static data-based restrictions may comprise one or more of:

```
    Forbid data set column email:
  NOT QueryColumns(email)
    Only return data set rows that have age column greater or equal to 18:
  QueryRows(age >= 18)
    Return data set rows where age < 18 with data set column email
  forbidden: NOT QueryColumns(email) AND QueryRows(age < 18)
    Return all data set rows but forbid data set column email when age <
  18: QueryRows(age >= 18)
      OR
    NOT QueryColumns(email) AND QueryRows(age < 18)
    Combination of two sub-restrictions:
      NOT QueryColumns(email)
        AND
      (
        QueryRows(age >= 18)
OR
NOT QueryColumns(email) AND QueryRows(age < 18)
```

Non-limiting examples of dynamic data-based restrictions may comprise one or more of:
Allow columns specified by attribute value
   QueryColumns($subject.attributes[‘allowed_columns’])
Return all data set rows where user_id column value matches subject's id:
QueryRows(user_id=$subject. subject_id)
Only return rows where data set column dept_no belongs to the dept_nos attribute value of security subject:
   QueryRows(dept_no member of $subject.attributes[‘dept_nos’])

Data Access Service Architecture

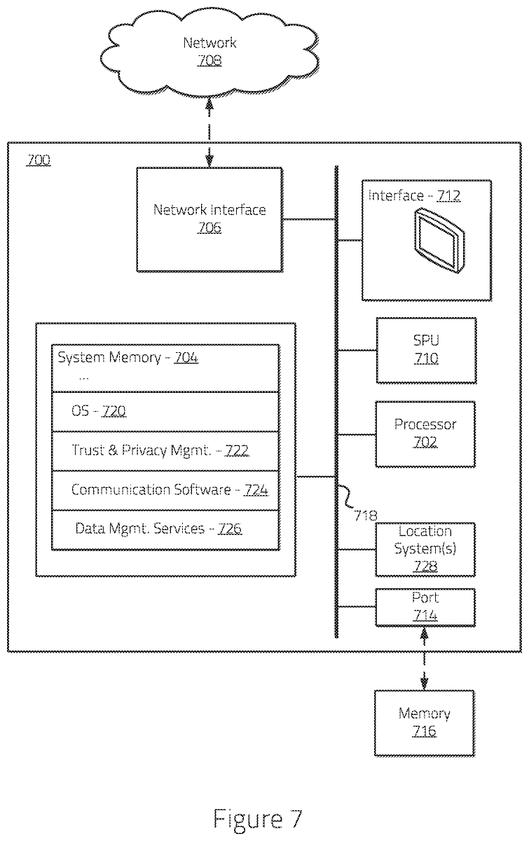

FIG. 7 illustrates an example of a system 700 that may be used to implement certain embodiments of the systems and methods of the present disclosure. The various systems, services, and/or devices used in connection with aspects the disclosed embodiments may be communicatively coupled using a variety of networks and/or network connections (e.g., network 708). In certain embodiments, the network 708 may comprise a variety of network communication devices and/or channels and may utilize any suitable communications protocols and/or standards facilitating communication between the systems and/or devices.

The network 708 may comprise the internet, a local area network, a virtual private network, and/or any other communication network utilizing one or more electronic communication technologies and/or standards (e.g., Ethernet or the like). In some embodiments, the network 708 may comprise a wireless carrier system such as a personal communications system (“PCS”), and/or any other suitable communication system incorporating any suitable communication standards and/or protocols. In further embodiments, the network 708 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), time divisional multiple access (“TDMA”), long-term evolution (“LTE”), orthogonal frequency-division multiplexing (“OFDM”), and/or the like. In certain embodiments, the network 708 may incorporate one or more satellite communication links. In yet further embodiments, the network may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

In certain embodiments, the example system 700 and/or aspects thereof may be used to implement and/or authenticate with trusted authentication services such as, for example, WebAuthn (FIDO2) authentication services. In certain embodiments, the system 700 may comprise, for example and without limitation, one or more geographic location determining sensors and/or systems 728 such as GPS. In some implementations, location information provided by such sensors and/or systems 728 may be considered trusted location information associated with a session under an applicable authentication protocol, and be used in connection with various access authorization and/or restriction enforcement operations consistent with various embodiments disclosed herein.

As illustrated in FIG. 7, the example system 700 may comprise: a processing unit 702; system memory 704, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 702; a port 714 for interfacing with removable memory 716 that may include one or more diskettes, optical storage mediums (e.g., flash memory, thumb drives, USB dongles, compact discs, DVDs, etc.) and/or other non-transitory computer-readable storage mediums; a network interface 706 for communicating with other systems via one or more network connections and/or networks 708 using one or more communication technologies; a user interface 712 that may include a display and/or one or more input/output devices such as, for example, a touchscreen, a keyboard, a mouse, a track pad, and the like; and one or more busses 718 for communicatively coupling the elements of the system 700.

In some embodiments, the system 700 may, alternatively or in addition, include an SPU 710 that is protected from tampering by a user of the system 700 or other entities by utilizing secure physical and/or virtual security techniques. An SPU 710 can help enhance the security of sensitive operations such as personal information management, trusted credential and/or key management, privacy and policy management, and other aspects of the systems and methods disclosed herein. In certain embodiments, the SPU 710 may operate in a logically secure processing domain and be configured to protect and operate on secret information, as described herein. In some embodiments, the

SPU 710 may include internal memory storing executable instructions or programs configured to enable the SPU 710 to perform secure operations, as described herein.

The operation of the system 700 may be generally controlled by the processing unit 702 and/or an SPU 710 operating by executing software instructions and programs stored in the system memory 704 (and/or other computer-readable media, such as removable memory 716). The system memory 704 may store a variety of executable programs or modules for controlling the operation of the system 700. For example, the system memory may include an operating system (“OS”) 720 that may manage and coordinate, at least in part, system hardware resources and provide for common services for execution of various applications and a trust and privacy management system 722 for implementing trust and privacy management functionality including protection and/or management of personal data through management and/or enforcement of associated policies. The system memory 704 may further include, without limitation, communication software 724 configured to enable in part communication with and by the system 700, one or more applications, data access management services 726 configured to implement various aspects of the disclosed systems and/or methods, and/or any other information and/or applications configured to implement embodiments of the systems and methods disclosed herein and/or aspects thereof

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein, but may be modified within the scope and equivalents of the appended claims.

What is claimed is:

1. A method for managing data performed by a data access service system comprising a processor and a non-transitory computer-readable storage medium storing instructions that, when executed by the processor, cause the data access service system to perform the method, the method comprising:
receiving, by the data access service system from a querying system, a first data access request, the first data access request comprising first identification information and an indication of a first data set managed by the data access service system;
issuing, by the data access service system, a first access authorization query to an identity and access management service, the first access authorization query comprising the first identification information and the indication of the first data set;
receiving, from the identity and access management service in response to the first access authorization query, a response validating the first identification information and providing at least one first restriction associated with access of the first data set in response to the first data access request;
identifying an execution environment of the querying system associated with the first data access request based on identifying which port of a plurality of ports of the data access service system the first data access request was received over; and
transmitting at least a subset of the first data set to the querying system, the at least a subset of the first data set being determined based on the identified execution environment and the at least one first restriction.

2. The method of claim 1, wherein the execution environment comprises an open execution environment.

3. The method of claim 2, wherein the identified port of the plurality of ports comprises a public port of the data access service system.

4. The method of claim 1, wherein the execution environment comprises a secure execution environment.

5. The method of claim 4, wherein the identified port of the plurality of ports comprises a private port of the data access service system associated with requests originating from protected environments.

6. The method of claim 1, wherein the method further comprises filtering the data set based on the at least one first restriction, wherein the at least a subset of the data set transmitted to the querying system comprises the filtered data set.

7. The method of claim 1, wherein the first identification information comprises identification information associated with a user of the querying system.

8. The method of claim 1, wherein the first identification information comprises identification information associated with a program executing on the querying system.

9. The method of claim 1, wherein the first identification information comprises identification information associated with the querying system.

10. The method of claim 1, wherein the first data set comprises a first virtual data set.

11. The method of claim 10, wherein the first virtual data set is associated with data stored in multiple data stores managed by the data access service system.

12. The method of claim 1, wherein the first identification information comprises an access token.

13. The method of claim 12, wherein the access token is issued by the identity and access management service to the querying system.

14. The method of claim 1, wherein the execution environment comprises a protected sandbox of a secure execution environment of the querying system.

15. The method of claim 1, wherein the method further comprises:
receiving, by the data access service system from the querying system, a second data access request, the second data access request comprising second identification information and an indication of a second data set managed by the data access service system;
issuing, by the data access service system, a second access authorization query to the identity and access management service, the second access authorization query comprising the second identification information and the indication of the second data set;
receiving, from the identity and access management service in response to the second access authorization query, a response validating the second identification information, an indication of a geographic location associated with the second identification information, and providing at least one second restriction associated with access of the second data set in response to the second data access request; and
transmitting at least a subset of the second data set to the querying system, the at least a subset of the second data set being determined based on the indication of the geographic location associated with the second identification information and the at least one second restriction.

16. The method of claim 15, wherein the first data set and the second data set comprise data that at least in part overlaps.

17. The method of claim 15, wherein the method further comprises storing at least a portion of the response validating the second identification information in a cache storage of the data access service system.

18. The method of claim 15, wherein the at least one first restriction and the at least one second restriction comprise a same restriction.

18. The method of claim 1, wherein the second identification information comprises an access token.

19. The method of claim 1, wherein the method further comprises storing at least a portion of the response validating the first identification information in a cache storage of the data management service system.

20. The method of claim 1, wherein the response received from the identity and access management service further comprises an indication of a geographic location associated with the first identification information and wherein the at least a subset of the first data set is further determined based on the indication of the geographic location associated with the first identification information and the at least one first restriction.
